(19) United States
(12) Patent Application Publication
(10) Pub. No.: US 2007/0157892 A1
(43) Pub. Date: Jul. 12, 2007

(54) LEASH ASSEMBLY FOR WALKING TWO OR MORE PETS

(75) Inventors: Ruth M. Farrell, Shaker Heights, OH (US); Mary W. Farrell, Shaker Heights, OH (US)

Correspondence Address: RENNER OTTO BOISSELLE & SKLAR, LLP, 1621 EUCLID AVENUE, NINETEENTH FLOOR, CLEVELAND, OH, 44115, US

(73) Assignee: HAPPY LUCKY DOG, LLC, Shaker Heights, OH (US)

(21) Appl. No.: 11/565,985

(22) Filed: Dec. 1, 2006

Related U.S. Application Data
(60) Provisional application No. 60/741,669, filed on Dec. 2, 2005.

(51) Int. Cl. A01K 27/00

(52) U.S. Cl. 119/795

(57) ABSTRACT

A leash assembly for restraining two or more animals includes a supplemental leash line that retains an attachment member and an animal attachment fastener. One feature is that the attachment member attaches to a main leash line so that the attachment member is freely moveable with respect to the main leash line from a handle at which a first end of the main leash line terminates to a main animal attachment fastener at which a second end of the main leash line terminates. Another feature is that an adjustment member is repositionable with respect to the supplemental leash line to selectively adjust a maximum distance between the attachment member and the animal attachment fastener.

### RELATED APPLICATION DATA

This application claims the benefit of U.S. Provisional Patent Application No. 60/741,669 filed Dec. 2, 2005, the disclosure of which is incorporated herein by reference in its entirety.

### TECHNICAL FIELD

The present invention generally relates to a pet leash and, more particularly, to a pet leash arranged to simultaneously walk or restrain multiple pets. The leash is well suited for use with dogs, although the leash may be used with other animals as well, and can be used for walking or restraining.

### BACKGROUND

As dogs and other pets provide companionship to people, the pets, in turn require care from their owners. Food, water and shelter are generally considered necessities. In addition, to maintain good physical and mental health, pets should be afforded a reasonable amount of exercise. The confined space in houses is usually not adequate to provide enough exercise and stimulation for dogs. In addition, most dogs are taken outside for bladder and bowel relief. Therefore, one responsibility of pet ownership may be walking the pets outside. Pet walking may occur multiple times each day. In urban areas, there are often laws that mandate that dogs be leashed when beyond property lines.

Many dog owners have more than one dog. This being the case, an owner must be able to control multiple dogs simultaneously while walking them. This can be done by using a leash for each pet, but this results in tangling and being pulled in two or different directions.

Therefore, there is a need in the art for a leash assembly that is easy to use when walking multiple pets and that has limited susceptibility to tangling while maintaining control over the pets.

### SUMMARY

According to one aspect of the invention, a leash assembly for restraining two or more animals includes a first leash line having a first end terminating at a handle and a second end terminating at a first animal attachment fastener; and a second leash line assembly having a second leash line that retains an attachment member and a second animal attachment fastener, wherein the first leash line extends through the attachment member so that the attachment member is freely moveable with respect to the first leash line from the handle to the first animal attachment fastener.

According to another aspect of the invention, a supplemental leash assembly is configured for attachment to a main leash assembly, the main leash assembly is configured to restrain a first animal and has a main leash line, and the supplemental leash assembly is configured to restrain a second animal with respect to the main leash line. The supplemental leash assembly includes a supplemental leash line; an attachment member retained by the supplemental leash line; an animal attachment fastener retained by the supplemental leash line; and an adjustment member that is repositionable with respect to the supplemental leash line to selectively adjust a maximum distance between the attachment member and the animal attachment fastener.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

### BRIEF DESCRIPTION OF THE DRAWINGS

These and further features of the present invention will be apparent with reference to the following description and drawings, wherein:

FIG. 1 is a perspective view of an exemplary leash assembly according to the present invention;

FIG. 2 is an enlarged view of a portion of the leash assembly if FIG. 1 where a secondary leash line joins a primary leash line;

FIG. 3 is a front view of a trigger snap for use in connecting a secondary leash line to a primary leash line in one embodiment of a leash assembly according to the present invention;

FIG. 4 is a front view of a secondary leash line adjustment member shown in isolation; and

FIG. 5 is a side view of another exemplary secondary leash line assembly with the adjustment member of FIG. 4 shown broken away.

### DETAILED DESCRIPTION OF EMBODIMENTS

In the description that follows, like components have been given the same reference numerals, regardless of whether they are shown in different embodiments. To illustrate an embodiment(s) of the present invention in a clear and concise manner, the drawings may not necessarily be to scale and certain features may be shown in somewhat schematic form. Features that are described and/or illustrated with respect to one embodiment may be used in the same way or in a similar way in one or more other embodiments and/or in combination with or instead of the features of the other embodiments.

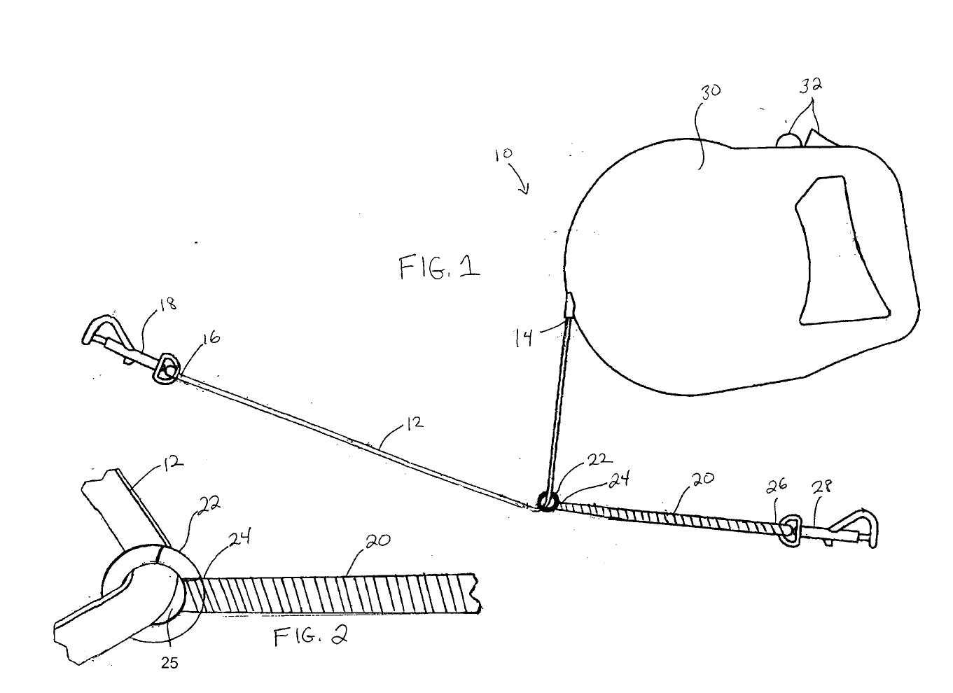

With reference to FIGS. 1 and 2, disclosed herein is a leash assembly 10 for controlling two or more animals, such as while walking two or more dogs. The animals will be referred to herein as dogs, but it will be appreciated that other animals may be restrained using the apparatus described herein, such as cats, pigs, monkeys and so forth. It will be appreciated, that the animals restrained by the leash assembly 10 need not be considered pets.

In the illustrated embodiment, the leash assembly 10 includes a retractable main line 12 (also referred to as a first leash line, a main leash and a primary leash line) that can be controlled at a first end 14 of the main line 12 by a user, such as a person walking the dogs. A second end 16 of the main line 12 can be attached to a swivable (e.g., rotatable) first animal attachment fastener 18, such as a spring biased clip that secures to a collar or harness worn by a first dog. Attachment to the fastener 18 can be made by looping the main line 12 through a receiving aperture of the fastener 18 and securing the main line 12 to itself, using, for example, stitches, adhesive and/or interweaving of the main line 12 material.

For an additional dog, there is a secondary line 20 (also referred to as a second leash line and a secondary leash). The secondary line 20 can be shorter in overall length than the main line 12. The secondary line 20 is attached to the main line 12 using an attachment member 22 disposed at a first end 24 of the secondary line 20. In particular, the attachment member 22 includes a through opening 25, through which the main line 12 extends. The attachment member 22 can be a ring, jump ring, clip, hook, snap hook, hoop or other suitable device or fastener. Another example includes a threaded ring, such as a “C” shaped member with at least one threaded end for threadably receiving an opening closure nut that is slidably connected to the other end. Attachment of the secondary line 20 to the member 22 can be made by looping the secondary line 20 through a receiving aperture of the member 22 and securing the secondary line 20 to itself, using, for example, stitches, adhesive and/or interweaving of the secondary line 20 material.

In the illustrated embodiment, the attachment member 22 is an annular coil resembling a key ring. In this embodiment, to attach the secondary line 20 to the main leash line 12, the main leash line 12 can be inserted between turns of the coil and the coil can be rotated until the main leash line 12 becomes entrapped in the coil. To remove the attachment member 22, the process can be reversed.

The attachment member 22 can be of multi-piece construction so that the secondary line 20 can rotate axially with respect to the main line 12.

A second end 26 of the second leash line 20 can be attached to a swivable (e.g., rotatable) second animal attachment fastener 28, such as a spring biased clip that secures to a collar or harness worn by a second dog. Attachment to the fastener 28 can be made by looping the secondary line 20 through a receiving aperture of the fastener 28 and securing the secondary line 20 to itself, using, for example, stitches, adhesive and/or interweaving of the secondary line 20 material.

In one embodiment, the secondary line 20 can be about 6 inches long to about 36 inches long, although the length can be varied to accommodate various sizes of dogs and needs of the user. In another embodiment, the secondary line 20 is about 18 inches long to about 36 inches long. The overall length of the main line 12 can be about 5 feet long to about 25 feet long, although the length can be varied to accommodate various sizes of dogs and needs of the user. In one embodiment, the main line 12 can be retracted so that the distance from the first end 14 (as defined by the point at which the main line 12 enters or engages a handle 30) to the second end 16 is shorter than the overall length of the main line 12. For example, a non-deployed portion of the main line 12 may be wound around a spool or held by hand, and that non-deployed portion of the main line 12 is not considered with determining the length of the main line 12 from the handle 30 to the fastener 18.

The lines 12 and 20 can be made of the same or different materials. Materials for the lines 12 and 20 include for example, a strap of natural or synthetic (e.g., nylon) material, leather, cord, rope, wire and so forth. The lines 12 and 20 are generally flexible in nature. The term line, as used herein, should not be considered limiting to shape (e.g., flat or round), material or construction.

The second leash line 20 can move freely along the length of the main leash line 12 from the first end 14 to the second end 16 without interruption by stops or other interference device. The attachment member 22 is configured to freely slide over the main leash line 12. In other words, the secondary leash 20 is free to float along the entire length of the main line 12 without restriction. For example, the attachment member 22 does not include a pulley or wheel that could become jammed with the main line 12. Rather, the attachment member 22 and the rest of the connected secondary line 20 is free to move along the entire length of the main line 12, without stops or blocks, thus providing a range of movement between the dogs while minimizing tangling of the lines 12 and 20. The member 22 is configured to minimize folding and/or binding of the main line 12.

The arrangement of the leash assembly 10 allows the dogs to wander in opposite directions with respect to the longitudinal axis of the main leash line 12, up to the maximum length of the main leash line 12 between the ends 14 and 16. In effect, the fastener 28 moves independently along the length of the main line 12 with respect to fastener 18. In addition, the user can maintain control of both dogs by manipulation of just the main leash line 12 as the second leash line 20 is laterally constricted relative to the main leash line 12.

The first end 14 can be defined by the relationship of the main line 12 to a handle 30. In one embodiment, the handle 30 is established by looping the main line 12 upon itself, in which case the distance between the first end 14 and the second end 16 is fixed.

In the illustrated embodiment, however, the main leash line 12 is secured to a handle 30 with a retraction mechanism to deploy a selected length of main leash line 12. The retraction mechanism is not shown in the illustrated embodiment and would be enclosed by the handle 30. The handle 30 can include an aperture, through which the main line 12 travels. Retractability of the main leash line 12 provides greater control options to the user. For example, the distance between the first end 14 and the second end 16 can be adjusted, thereby allowing changes in the distance between at least the dog secured by first animal attachment fastener 18 and the user. The second dog can move up and down the length of the main line 12 without restriction, depending on how much of the main line 12 the user lets out of the handle.

Examples of the retractable operation of an animal leash are described in U.S. Pat. Nos. 3,693,596, 3,937,418 and 4,562,792, the disclosures of which are incorporated by reference herein in their entireties. The handle 30 can house a retracting mechanism that includes a spring and spool that rotate in a manner to coil the main line 12. The specific arrangement of the retracting mechanism can vary and can include any appropriate clutch, lock, brake, release and so forth, which can be controlled by buttons 32.

In an example operational configuration, the main leash line 12 is clipped to the collar of the first dog with fastener 18 and the secondary leash line 20 is clipped to the collar of the second dog with fastener 28. As the user walks the dogs, the user can release as much of the main leash line 12 as desired up to the overall length of the main leash line 12, thereby increasing or decreasing the range of movement for the dogs. When more control is desired, the user can reel the dogs in, and when space is available, the user can release the main leash line 12 to the fullest extent to allow the dogs to roam more freely.

The main line 12 can be controlled by the user to maintain a slight tension and elevate the lines 12 and 20 off the ground. It is contemplated that such tension and/or elevation may reduce the likelihood that the lines 12 and 20 will become tangled.

The secondary leash 20 can be removed from the main leash line 12 if just one dog is to be walked. Alternatively, the second animal attachment fastener 28 can be clipped to the first animal attachment fastener 18 or the handle 30 to be stowed when not in use.

Plural secondary leashes 20, with accompanying attachment members 22 and fasteners 28 can be connected to the main line 12 so that three or more dogs can be simultaneously walked and controlled with the main line 12.

As will be appreciated, the disclosed leash assembly 10 has a relatively simple construction that is easier and less expensive to manufacture than conventional multiple dog leashes. In addition, the leash assembly can be efficiently used. For example, the leash assembly 10 allows for a high degree of freedom of movement for the dogs and a high degree of control over the dogs by the user. The user need only control the main leash line 12 to control both dogs and, compared to using separate leashes for both dogs, the leash assembly 10 can reduce tangling, confusion and the stress of trying to negotiate a separate leash for each dog. Retractability of the main line 12 gives the user control over the dogs by allowing the user to pull the dogs in close with relative ease. It is contemplated that the dogs appreciate the ability to wander apart along the length of the main leash line 12.

The leash assembly 10 can be adapted to accommodate dogs of various sizes. For smaller dogs, the leash lines 12 and 20 lengths can be made shorter and with finer cord or straps. For larger dogs, the leash lines 12 and 20 lengths can be made longer, with larger cord or straps to increase tensile strength.

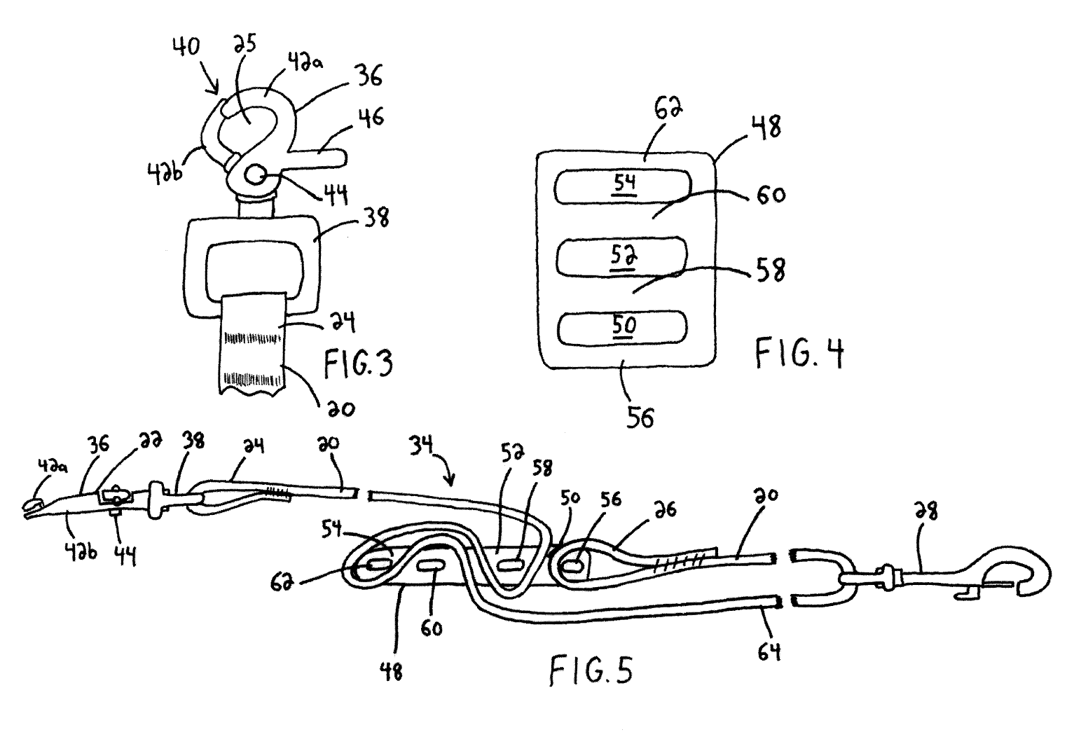

With additional reference to FIGS. 3 through 5, another exemplary embodiment of a secondary leash line assembly 34 will be described. In this embodiment, the effective length of a secondary leash line 20 is made to be variable (or adjustable) in length. Similar to the embodiment of FIGS. 1 and 2, the secondary line 20 may be removably secured to the first leash line 12 with an attachment member 22 located at a first end of the secondary line 20.

In the illustrated embodiment, the attachment member 22 is a device commonly referred to in the hardware industry as a trigger snap 36. The illustrated trigger snap 36 has a ring 38 through which a first end 24 of the secondary line 20 is passed before the secondary line 20 is secured to itself in any suitable manner, such as by stitching. Swivably (e.g., rotatably) attached to the ring 38 is a clasp component 40. The clasp component 40 may include two members 42a and 42b that are joined by an axel 44, which may be implemented with a pin, rivet or threaded assembly. A spring is coiled around the axel 44 and biases the members 42 into a closed position as shown. The spring may be located in interior recesses of the members 42 and, therefore, is not visible in the illustrated views. The members 42 are curved to form a through opening 25 when in the closed position. Also, the members are 42 are tapered at ends opposite the axel 44 to overlap one another. Force may be applied to a lever 46 that is attached to one of the members 42a to counteract the biasing force of the spring and to pivot the member 42a with respect to the member 42b. The resulting movement spaces the overlapping ends of the members 42 apart so that the trigger snap 36 may be attached to the first line 12 or removed from the first line 12 by passing the first line 12 through the space between the members 42.

As will be appreciated, when the members 42 of the trigger snap 36 surround the first line 12, the trigger snap 36 is freely moveable along the length of the first leash line 12 from the handle 30 (e.g., retraction mechanism housing, strap loop or other grasping member) to the first animal attachment fastener 18.

As indicated, the effective length of the second leash line 20 may be adjustable. To facilitate adjustability, an adjustment member 48 may be employed. The adjustment member 48 may be any suitable device or assembly, examples of which include a tri-slide, a d-ring, a clamp, a slide and/or slide release, a reducer, a buckle, a loop fastener, a locking clip, and so forth. The adjustment member 48 may be made from any suitable material, including metal or plastic.

The illustrated adjustment member 48 has three openings 50, 52 and 54 defined in part by four cross members 56, 58, 60 and 62. A second end 26 of the second leash line 20 is passed through the first opening 50 before the secondary line 20 is secured to itself in any suitable manner, such as by stitching. Thus, the first end 24 is secured around a first cross-member 56 of the adjustment member.

It is noted that in the view of FIG. 5, the adjustment member 48 is shown partially broken away.

Proceeding along the length of the second leash line 20 from the first end 24, the second leash line 20 passes through an aperture of a second animal attachment fastener 28. The illustrated fastener used for the second animal attachment fastener 28 (as well as the first and second animal attachment fasteners of FIG. 1) is commonly referred to in the hardware industry as a bolt snap.

Thereafter, the second leash line 20 passes upwardly through the second opening 52 between the second and third cross-members 58 and 60. The second leash line 20 passes over the third cross-member 60 and through the third opening between the third and fourth cross-members 60 and 62. The second leash line 20 then wraps around the fourth cross member and over the portion of the second leash line 20 that crosses over the third cross-member 60 before passing back through the second opening 52. Thereafter, the second leash line wraps around the second cross-member and passes through the first opening 50. In this arrangement, the second leash line 20 doubles over itself while passing through the various openings of the adjustment member and around the various cross-members of the adjustment member. In this manner, a loop 64 may be formed in the second leash line 20. The length of the loop 64 may be determined by the relatively placement of the adjustment member 48 and the second leash line 20. Little movement of the adjustment member 48 with respect to the second leash line 20 will be experienced when the second leash line 20 undergoes tensioning between the second animal attachment fastener 28 and the attachment member 22. To adjust the length of the loop 64 and, hence, the overall length between the members 22 and 28, the second leash line 20 may be loosen with respect to the adjustment member 48 by manual effort of pushing and pulling the leash line 20 through the respective openings of the adjustment member 48. By loosing the second leash line 20 in this manner, the adjustment member 48 may be moved relative to the leash line 20 and the length of the loop 64 may be changed.

In one embodiment, the overall length of the second leash line 20 may be about one foot to about six feet. In one embodiment, the overall length of the second leash line 20 is about three feet and, depending on where the user places the adjustment member 48 with respect to the second leash line 20, the distance between the members 22 and 28 may be about one foot to about two and a half feet. In one embodiment, the second leash line 20 has a length so that a maximum distance between the attachment member 22 and the second animal attachment fastener 28 is about three feet.

Adjustability of the length of the second leash line 20 may be advantageous when pets of different breeds, ages and/or sizes are walked using the leash line assembly 10. For instance, when walking two large dogs (e.g., greyhounds), it may be desirable to shorten the loop 64 to increase the distance between the members 22 and 28. In another example, when waling two small dogs (e.g., Chihuahuas), it may be desirable to lengthen the loop 64 to decrease the distance between the members 22 and 28 so as to minimize the possibility that the second least line 20 drags on the ground.

Although particular embodiments of the invention have been described in detail, it is understood that the invention is not limited correspondingly in scope, but includes all changes, modifications and equivalents coming within the spirit and terms of the claims appended hereto.

What is claimed is:

1. A leash assembly for restraining two or more animals, comprising:
a first leash line having a first end terminating at a handle and a second end terminating at a first animal attachment fastener; and
a second leash line assembly having a second leash line that retains an attachment member and a second animal attachment fastener, wherein the first leash line extends through the attachment member so that the attachment member is freely moveable with respect to the first leash line from the handle to the first animal attachment fastener.

2. The leash assembly of claim 1, wherein the first leash line has a length of up to about twenty-five feet and the second leash line has a length of up to about three feet.

3. The leash assembly of claim 1, wherein the leash assembly includes plural second leash line assemblies and the first leash line extends through the attachment member of each second leash line assembly.

4. The leash assembly of claim 1, wherein the handle is a retracting handle that controls the effective length of the first leash line between the handle and the first animal attachment fastener.

5. The leash assembly of claim 1, wherein the handle is a loop formed from the first leash line.

6. The leash assembly of claim 1, wherein the attachment member defines an aperture, the first leash line passing through the aperture and the second leash line passing through the aperture to form a loop to secure the second leash line to itself.

7. The leash assembly of claim 1, wherein the attachment member is a trigger snap.

8. The leash assembly of claim 1, further comprising an adjustment member, the adjustment member and the second leash line repositionable with respect to each other to selectively adjust a maximum distance between the attachment member and the second animal attachment fastener.

9. The leash assembly of claim 8, wherein the adjustment member has a plurality of openings through which the second leash line passes in a pattern to minimize movement of the adjustment member with respect to the second leash line when the second leash line undergoes tensioning between the second animal attachment fastener and the attachment member.

10. A supplemental leash assembly configured for attachment to a main leash assembly, the main leash assembly configured to restrain a first animal and has a main leash line, and the supplemental leash assembly configured to restrain a second animal with respect to the main leash line, the supplemental leash assembly comprising:
a supplemental leash line;
an attachment member retained by the supplemental leash line;
an animal attachment fastener retained by the supplemental leash line; and
an adjustment member that is repositionable with respect to the supplemental leash line to selectively adjust a maximum distance between the attachment member and the animal attachment fastener.

11. The supplemental leash assembly of claim 10, wherein the adjustment member has a plurality of openings through which the supplemental leash line passes in a pattern to minimize movement of the adjustment member with respect to the supplemental leash line when the supplemental leash line undergoes tensioning between the animal attachment fastener and the attachment member.

12. The supplemental leash assembly of claim 10, wherein the supplemental leash assembly is configured to attach to the main leash line by surrounding the main leash line with the attachment member and, when surrounding the main leash line, the attachment member is freely moveable with respect to the main leash line from a handle at which a first end of the main leash line terminates to an animal attachment fastener at which a second end of the main leash line terminates.

13. The supplemental leash assembly of claim 10, wherein the supplemental leash line has a length so that the maximum distance between the attachment member and the animal attachment fastener is about three feet.

14. The supplemental leash assembly of claim 10, wherein the attachment member defines an aperture through which the supplemental leash line passes to form a loop to secure the supplemental leash line to itself and the supplemental leash assembly is configured to attach to the main leash line by surrounding the main leash line with the attachment member so that the main leash line passes through the aperture.

15. The supplemental leash assembly of claim 10, wherein the attachment member is a trigger snap.

16. A leash assembly for restraining two or more animals, comprising:
the supplemental leash assembly of claim 10; and
a main leash assembly having a main leash line that terminates at a first end at a handle and terminates at a second end at a main animal attachment fastener, wherein the main leash line passes through the attachment member.

17. The leash assembly of claim 16, wherein the attachment member is freely moveable with respect to the main leash line from the handle to the main animal attachment fastener.

18. The leash assembly of claim 16, wherein the handle is a retracting handle that controls the effective length of the main leash line between the handle and the main animal attachment fastener.

19. The leash assembly of claim 16, wherein the handle is a loop formed from the main leash line.

20. The leash assembly of claim 16, wherein the attachment member is a trigger snap.
